(19) United States
(12) Patent Application Publication
(10) Pub. No.: US 2012/0047450 A1
(43) Pub. Date: Feb. 23, 2012

(54) INFORMATION PROCESSING APPARATUS AND METHOD OF CONTROLLING SAME

(75) Inventor: Masaaki Sato, Yokohama-shi (JP)

(73) Assignee: CANON KABUSHIKI KAISHA, Tokyo (JP)

(21) Appl. No.: 13/177,039

(22) Filed: Jul. 6, 2011

(30) Foreign Application Priority Data
Aug. 18, 2010 (JP) 2010-183387

(51) Int. Cl. G06F 3/048; G06F 15/16

(52) U.S. Cl. 715/760

(57) ABSTRACT

An information processing apparatus having a web browser analyzes a request that has been input using an operation screen being displayed by the web browser, refers to information, based upon result of this analysis, identifying the type and issuing source of a request, which has been issued from the application or web browser, and an operation screen displayed by the application launched in accordance with the request or by the web browser, and identifies an operation screen that is to be displayed by the application launched in accordance with the request or by the web browser. When the operation screen displayed by the application is identified, the operation screen based upon the web browser is closed and a screen display request is issued to the application.

### BACKGROUND OF THE INVENTION

1. Field of the Invention

The present invention relates to an information processing apparatus provided with an operation screen from a server and a method of controlling this apparatus.

2. Description of the Related Art

In general, an information processing apparatus such as a personal computer is connected to a web server over a network, an operation screen for operating the information processing apparatus is provided by the web server and is displayed on a web browser with which the information processing apparatus is equipped. In this case, the web browser of the information processing apparatus requests the web server for the operation screen and a web application at the web server responds to this request by sending to the information processing apparatus an HTML file for displaying the operation screen on the web browser. The web browser of the information processing apparatus then analyzes the received HTML file and displays the operation screen that is based upon the description in this HTML file. Further, when the user enters an instruction via the operation screen displayed on the web browser, the web browser notifies the web server of the entered instruction. The web application at the web server thus notified executes processing in accordance with this instruction and sends to the information processing apparatus an HTML file for the operation screen to be displayed next.

Multifunction peripherals (MFPs) having a scanner and printer also have recently come to be equipped with such a web browser. Through the above-described procedure, such an MFP displays the operation screen provided by the web server on the web browser of the MFP and is capable of accepting various instructions from the user. Therefore, the MFP generally utilizes an operation screen which allows operating the inherent functions such as the copying and transmitting functions (these functions will be referred to as “native functions” below) and an operation screen that is based upon the web browser.

The specification of Japanese Patent Laid-Open No. 6-60033 describes art in which the launching of an application is restricted based upon password information that has been input by a user.

An MFP can be provided with functions in addition to the native functions by a method in which the user or administrator installs an application at a later time. Such functions are referred to as “additional functions”. In an environment in which user authentication is necessary in order to utilize the native functions of an MFP and a web server provides an operation screen for the purpose of such user authentication, it is difficult to carry out user authentication for additional functions in the same way as is performed for native functions.

### SUMMARY OF THE INVENTION

An aspect of the present invention is to eliminate the above-mentioned problems with conventional technology.

A characterizing feature of the present invention is to provide a technique whereby a function provided by a web server can be utilized as an additional function of an information processing apparatus.

According to an aspect of the present invention, there is provided an information processing apparatus having a web server, comprising: an application configured to execute a function possessed by the information processing apparatus; a storage unit configured to store information identifying the type and issuing source of a request, which has been issued from the application or the web browser, and an operation screen displayed by the application or the web browser in response to the request; an analyzing unit configured to analyze a request that has been input using an operation screen being displayed by the web browser or the application; an identification unit configured to refer to the stored information based upon result of analysis by the analyzing unit and identify an operation screen that is to be displayed by the application or the web browser; and a requesting unit configured to request the application or the web browser to display the operation screen identified by the identification unit.

Further features of the present invention will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is an overall diagram of an information processing system according to an embodiment of the present invention;

FIG. 2 is a block diagram illustrating the configuration of an MFP according to this embodiment;

FIG. 3 is a block diagram illustrating the configuration of a web server according to this embodiment;

FIG. 4 is a diagram useful in describing the software configuration of an information processing system according to this embodiment;

FIG. 5 is a flowchart for describing an exchange between an MFP and a web server according to this embodiment;

FIG. 6 is a flowchart for describing processing executed by an MFP according to this embodiment;

FIG. 7A is a diagram illustrating an example of a screen presented to a user of an MFP;

FIG. 7B is a diagram illustrating an example of a screen presented to a user in regard to starting the processing of the flowchart shown in FIG. 6;

FIG. 8 is a diagram illustrating an example of an operation screen management table managed by an operation screen management section;

FIG. 9A is a diagram illustrating an example of a screen showing an “ERROR SCREEN” displayed when an error response is sent back;

FIG. 9B is a diagram illustrating an example of a screen showing a “WITH-AUTHENTICATION TOP SCREEN”, which conforms to the content of an authentication result;

FIG. 10A is a diagram illustrating an example of a screen in which a “WITHOUT-AUTHENTICATION TOP SCREEN” is displayed;

FIG. 10B is a diagram illustrating an example of an application function screen;

FIG. 11A is a diagram illustrating an example of a screen for designating an image conversion file;

FIG. 11B is a diagram illustrating an example of a screen of a “TRANSMIT SCREEN” provided by a native function application; and

FIG. 12 is a diagram illustrating an example of an operation screen management table managed by an operation screen management section.

### DESCRIPTION OF THE EMBODIMENTS

Embodiments of the present invention will now be described hereinafter in detail, with reference to the accompanying drawings. It is to be understood that the following embodiment is not intended to limit the claims of the present invention, and that not all of the combinations of the aspects that are described according to the following embodiment are necessarily required with respect to the means to solve the problems according to the present invention.

A first embodiment of the present invention will now be described. The first embodiment will be described with regard to an example in which an MFP, which is one example of an information processing apparatus according to the present invention, executes authentication processing for authenticating a user and transmits a user ID used in this authentication processing to a web server to request the web server for an operation screen that is to be displayed by a web browser that has been installed in the MFP. In response to the request, a web application running on the web server determines whether the user ID has been received from the MFP and, if the user ID has been received, transmits the operation screen to the MFP.

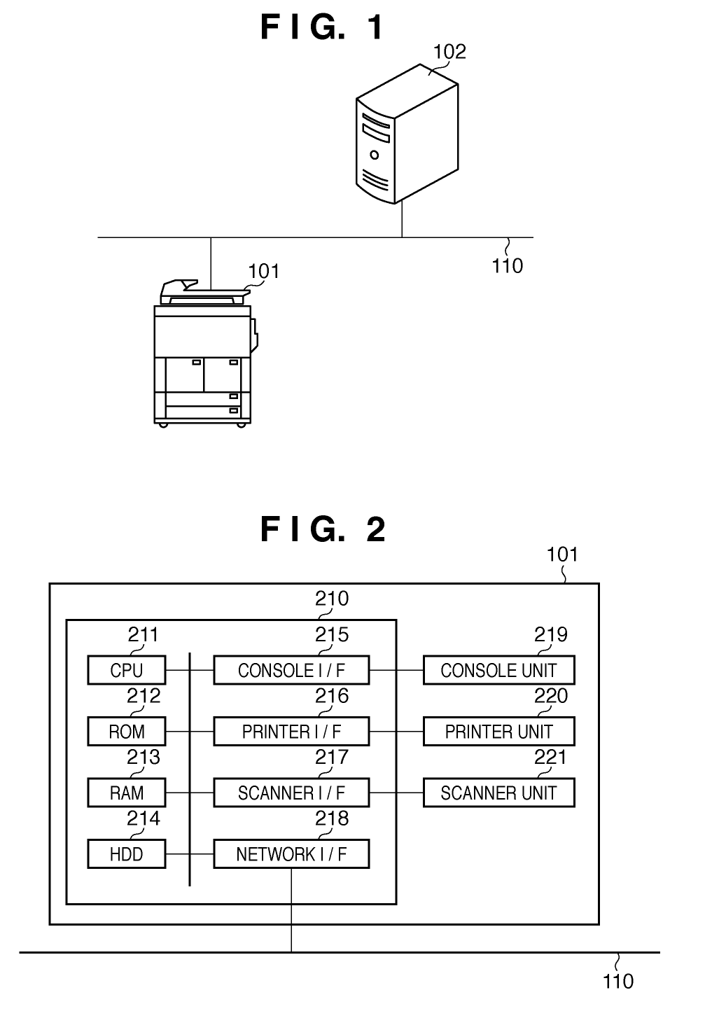

FIG. 1 is an overall diagram of an information processing system according to an embodiment of the present invention.

An MFP 101 and a web server 102 are connected to a LAN 110 so as to be capable of communicating with each other. The MFP 101 has a printer function, a scanner function, a facsimile function and a storage function, which is for storing data. The web server 102 provides the operation screen of the MFP 101. The web server 102 is capable of authenticating the user who operates the MFP 101. It may be arranged so that an authenticating server (not shown) other than the web server 102 may be connected to the LAN 110 and may authenticate the user of the MFP 101.

FIG. 2 is a block diagram illustrating the configuration of the MFP 101 according to this embodiment.

A control unit 210 that includes a CPU 211 controls the overall operation of the MFP 101. The CPU 211 executes a boot program that has been stored in a ROM 212, loads a control program, which has been stored on an HDD (hard-disk drive) 214, into a RAM 213 and executes various control processing such as processing for controlling reading and transmission. The RAM 213 is further used as a temporary storage area such as the main memory and work area of the CPU 211. The HDD 214 stores image data, a program for executing processing illustrated by a flowchart to be described later, and various information tables, described later.

A console interface (I/F) 215 controls the interface between a console unit 219 and the control unit 210. The console unit 219 is equipped with a liquid crystal display having a touch-sensitive panel, a keyboard, keys and LEDs, etc. The MFP 101 is equipped with a web browser function, described later. The web browser of the MFP 101 analyzes an HTML file received from the web server 102 and displays an operation screen, which is based upon the description set forth in the HTML file, on the console unit 219. A printer I/F 216 connects a printer unit 220 and the control unit 210. Image data to be printed by the printer unit 220 is transferred from the control unit 210 to the printer unit 220 via the printer I/F 216 and is printed on a printing medium such as a sheet by the printer unit 220. A scanner I/F 217 connects a scanner unit 221 and the control unit 210. The scanner unit 221 reads the image on a document, generates image data and inputs the image data to the control unit 210 via the scanner I/F 217. A network I/F 218 transmits image data and various information to external units (e.g., the web server 102 and an LDAP server, which is not shown) on the LAN 110 and receives various information from the external units on the LAN 110.

It should be noted that the control unit 210 in FIG. 2 is illustrated by way of example to have the single CPU 211. However, the control unit 210 may just as well have a configuration that includes multiple CPUs.

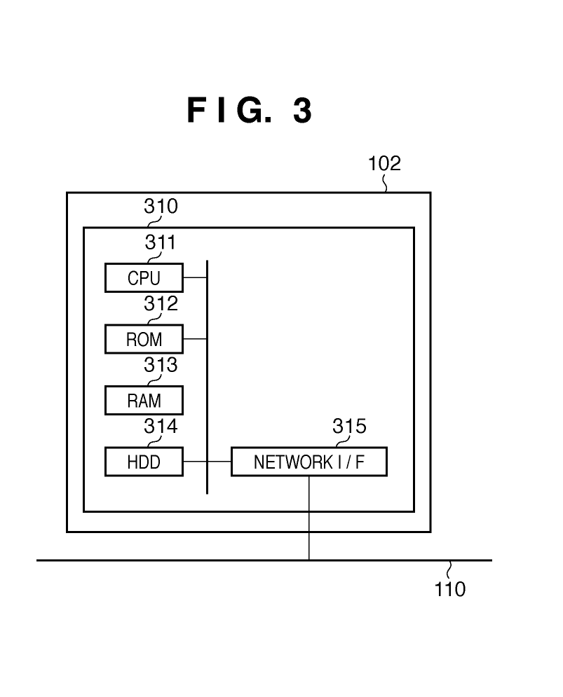

FIG. 3 is a block diagram illustrating the configuration of the web server 102 according to this embodiment.

A control unit 310 including a CPU 311 controls the overall operation of the web server 102. The CPU 311 executes a boot program that has been stored in a ROM 312, reads a control program, which has been stored on an HDD 314, loads the program into a RAM 313 and executes the program to thereby execute various control processing. The RAM 313 is further used as a temporary storage area such as the main memory and work area of the CPU 311. The HDD 314 stores image data, HTML files, various programs and various information tables, described later. A network I/F 315 connects the control unit 310 (web server 102) to the LAN 110. The network I/F 315 sends and receives various information to and from other units on the LAN 110.

It should be noted that the web server 102 in FIG. 3 is illustrated by way of example to be composed of a single server. However, the functions of the web server 102 may just as well be implemented by multiple servers. Further, the web server 102 may just as well have a configuration that includes multiple CPUs.

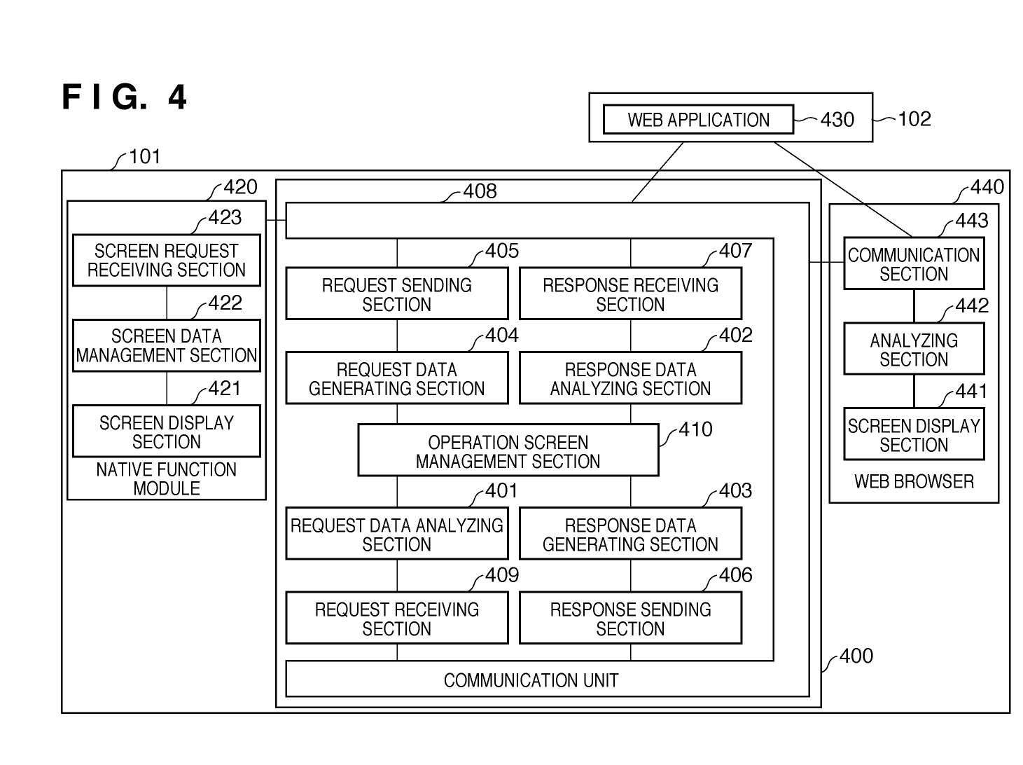

FIG. 4 is a diagram useful in describing the software configuration of the overall information processing system according to the first embodiment of the present invention. The functional units shown in FIG. 4 are implemented by having the CPUs provided in respective ones of the MFP 101 and web server 102 execute the corresponding software (programs).

The MFP 101 has an application switching module 400, a web browser 440 and a native function module 420. The web server 102 has a web application 430.

The application switching module 400 includes an operation screen management section 410, a request data analyzing section 401, a response data analyzing section 402, a response data generating section 403, a request data generating section 404, a request sending section 405, a response sending section 406, a response receiving section 407, a communication section 408 and a request receiving section 409.

The application switching module 400 will be described first.

In order to arrange it so that the operation screen displayed on the console unit 219 may be switched, the operation screen management section 410 manages the web browser screen and the native screen to be launched or the web application 430. Further, the operation screen management section 410 manages information relating to which application has transmitted a request, the type of request content designated, and which application is to be launched. The request data analyzing section 401 analyzes the content of request information (an HTTP request, for example) that the request receiving section 409 has received from the web browser 440 and recognizes information that has been set forth in this request. The response data analyzing section 402 analyzes the content of response information (e.g., an HTTP response such as an HTML file) that the response receiving section 407 has received from the web server 102 and recognizes information that has been set forth in this response. The response data generating section 403 generates response information (an HTTP response, for example) in the format of an HTML file or the like capable of being displayed on the screen by the web browser 440. More specifically, the response data generating section 403 generates response information from the response information received from the web application 430. The request data generating section 404 generates request information (an HTTP request, for example) directed to the web application 430. The request sending section 405 transmits the request information generated by the request data generating section 404 to the web server 102. The response sending section 406 transmits the response information, which has been generated by the response data generating section 403, in the format of an HTML file or the like capable of being displayed on the browser screen. The response receiving section 407 receives the response information, which is transmitted from the web server 102, in the format of an HTML file or the like capable of being displayed on the browser screen. The request receiving section 409 receives request information (an HTTP request, for example) from the web browser 440. The communication section 408 communicates with the web server 102, web browser 440 and native function module 420 in accordance with the HTTP protocol or the like.

The web browser 440 will be described next.

The web browser 440 includes a communication section 443, an analyzing section 442 and a screen display section 441. The communication section 443 communicates with the web application 430 and the application switching module 400 in accordance with the HTTP protocol. More specifically, the communication section 443 requests the web application 430 for an operation screen displayed by the web browser 440. An instruction from the user that has been input via the operation screen displayed by the web browser 440 is sent to the web application 430. The analyzing section 442 analyzes the HTML file received from the web application 430. The HTML file includes a description indicating the contents of the operation screen to be displayed on the web browser 440. The screen display section 441 displays the operation screen on the console unit 219 based upon the result of analysis by the analyzing section 442. The screen thus displayed based upon the information (HTML file) received from the web server 102 shall be referred to as a “web browser screen”.

The native function module 420 will be described next. The native function module 420 implements the functions intrinsic to the MFP 101 (at the time of shipping, for example), examples of which are a copy function, facsimile transceive function, scan function, storage function and the like. Such a function intrinsic to the MFP 101 shall be referred to as a “native function”.

The native function module 420 includes a screen data management section 422, a screen request receiving section 423 and a screen display section 421. The screen data management section 422 manages information relating to the operation screen of the native functions. The screen request receiving section 423 receives a screen display request for displaying the native-function-related operation screen on the console unit 219. By receiving the screen display request, the screen display section 421 displays the operation screen on the console unit 219. The screen which the native function module 420 thus displays on the console unit 219 by receiving the screen display request shall be referred to as a “native screen”.

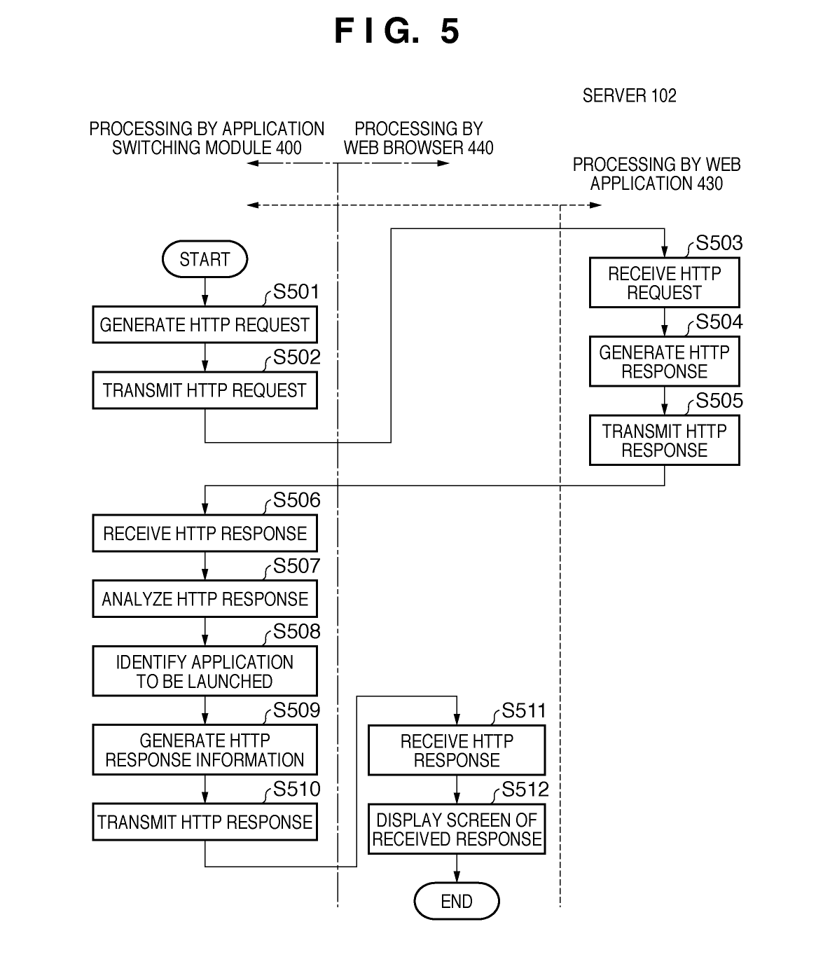

FIG. 5 is a flowchart for describing an example of an exchange between the MFP 101 and the web server 102 according to this embodiment. It should be noted that those processing steps among those shown in FIG. 5 that are executed by the application switching module 400 and those executed by the web browser 440 are implemented by having the CPU 211 of MFP 101 execute a control program, whereas those processing steps executed by the web application 430 are implemented by having the CPU 311 of web server 102 execute a program.

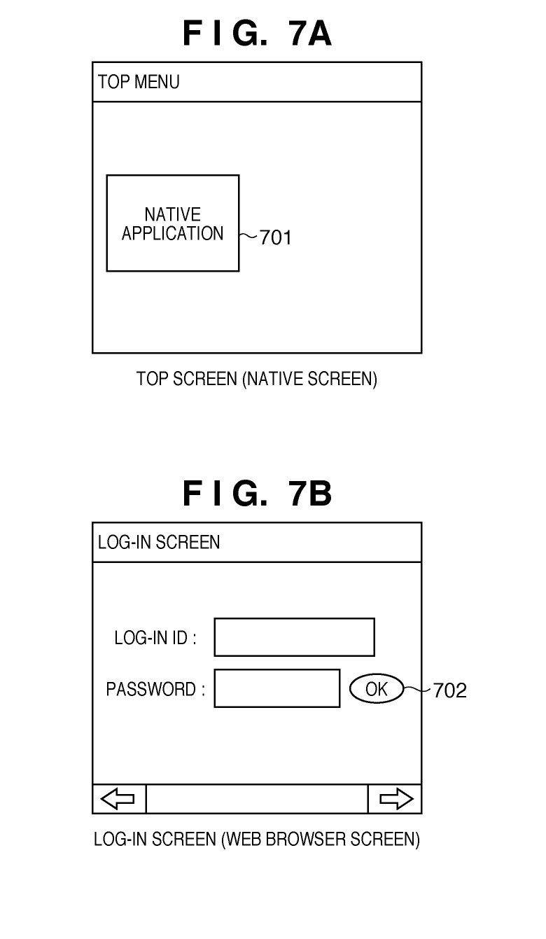

FIG. 7A is a diagram illustrating an example of a top screen (initial screen) presented to the user by being displayed on the console unit 219 of the MFP 101 in connection with the start of the processing shown in FIG. 5.

When a button 701 in FIG. 7A is pressed, the launching of a native function application provided by the top menu begins. The web server 102 provides the operation screen displayed on the console unit 219 so that the user of the MFP 101 of this embodiment may perform an operation related to the native function. When the button 701 is pressed, a “start request” is transmitted to the application switching module 400 and the processing of FIG. 5 starts. Steps S501 and S502 and steps S506 to S510 are processing steps executed by the application switching module 400. Steps S503 to S505 are processing steps executed by the web application 430, and steps S511 and S512 are processing steps executed by the web browser 440.

In step S501, the request data generating section 404 generates an HTTP request such as an HTML file for transmission to the web application 430. The HTTP request generated in step S501 includes information indicating that the button 701 has been pressed. Next, in step S502, the request sending section 405 sends the web application 430 the HTTP request generated in step S501. The request sending section 405 transmits this HTTP request via the communication section 408.

As a result, the web application 430 of the web server 102 receives the HTTP request in step S503. Control then proceeds to step S504, where the web application 430 interprets the received HTTP request and generates an HTTP response. More specifically, the web application 430 analyzes the information, which is included in the HTTP request, indicating that the button 701 has been pressed, and generates an HTML file as the response. The content described in this HTML file is indicative of “LOG-IN SCREEN DISPLAY”. Then, in step S505, the web application 430 transmits the HTTP response to the MFP 101.

In step S506, the response receiving section 407 receives the HTTP response transmitted via the communication section 408 in step S505. This is followed by step S507, where the response data analyzing section 402 analyzes the received HTTP response and recognizes what type of response information has been received. Next, in step S508, the operation screen management section 410 acquires a list of launch application information and, based upon the acquired list information and information concerning the response analyzed in step S507, identifies the operation screen that is to be displayed on the console unit 219.

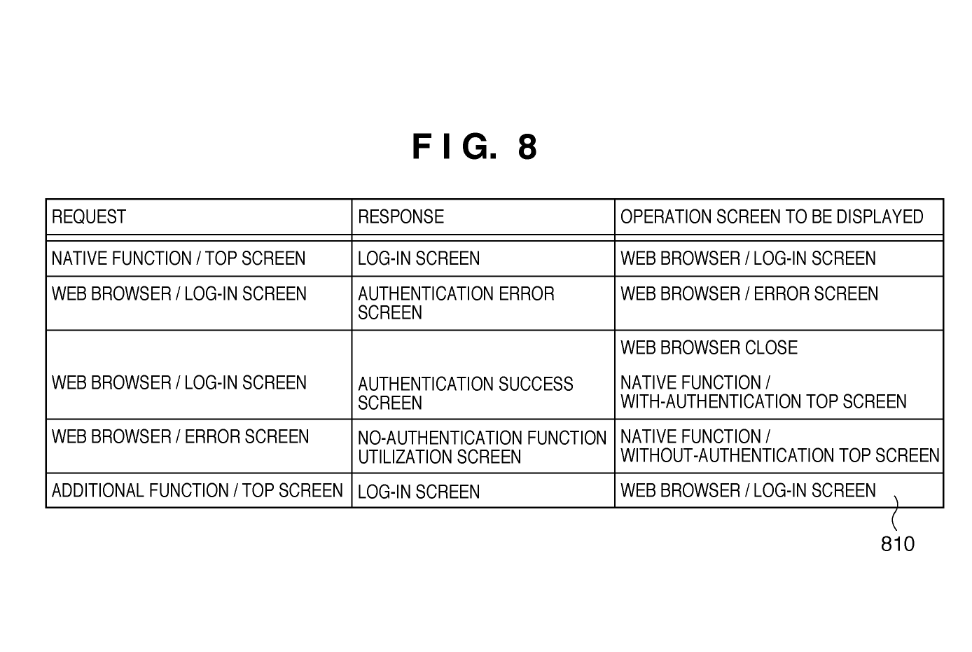

FIG. 8 is a diagram illustrating an example of an operation screen management table managed by the operation screen management section 410.

In the table shown in FIG. 8, “REQUEST” indicates the transmission source (issuing source) that transmitted the request as well as the type of operation screen that was being displayed on the console unit 219 when the request was issued. “RESPONSE” describes the type of response information received from the web server 102. “OPERATION SCREEN TO BE DISPLAYED” indicates the operation screen to be displayed on the console unit 219 and the principal software module that displays this operation screen.

If execution of the flowchart of FIG. 5 has been started by pressing the button 701 of FIG. 7A, then, in accordance with the operation screen management table of FIG. 8, the “REQUEST” is “NATIVE FUNCTION/TOP SCREEN” and the “RESPONSE” is “LOG-IN SCREEN”. Accordingly, the operation screen to be displayed on the console unit 219 becomes a log-in screen displayed by the web browser 440.

With reference again to the flowchart of FIG. 5, the log-in screen (web browser screen) is identified in step S508 as the operation screen to be displayed.

Next, in step S509, the response data generating section 403 generates response information indicating the operation screen identified in step S508. This response information is in a format (such as that of an HTML file) capable of being processed by the web browser 440. Next, in step S510, the response sending section 406 sends the web browser 440 the response information generated in step S509.

As a result of the foregoing, the web browser 440 receives the response information via the communication section 443 in step S511. Control then proceeds to step S512. Here the analyzing section 442 analyzes the response information and displays the operation screen (here the log-in screen) on the console unit 219 based upon the result of analysis. FIG. 7B illustrates an example of the log-in screen displayed on the console unit 219 owing to execution of step S512. The log-in screen prompts the user to input authentication information (a user ID and its password) needed in order to log in. When the user enters a user ID and its password on the log-in screen, the entered information is transmitted to the web application 430 via the application switching module 400. If user authentication processing based upon the user ID and password succeeds at the web application 430, it becomes possible for the user to utilize a native function. The operation screen for utilizing this native function is generated by the web application 430, presented to the web browser 440 and displayed on the console unit 219.

Thus, by executing the flowchart of FIG. 5, it becomes possible for the operation screen to perform log-in to be displayed on the web browser 440 in a case where a function provided by the native function module 420 has been selected by the user (in other words, in a case where the button 701 has been pressed).

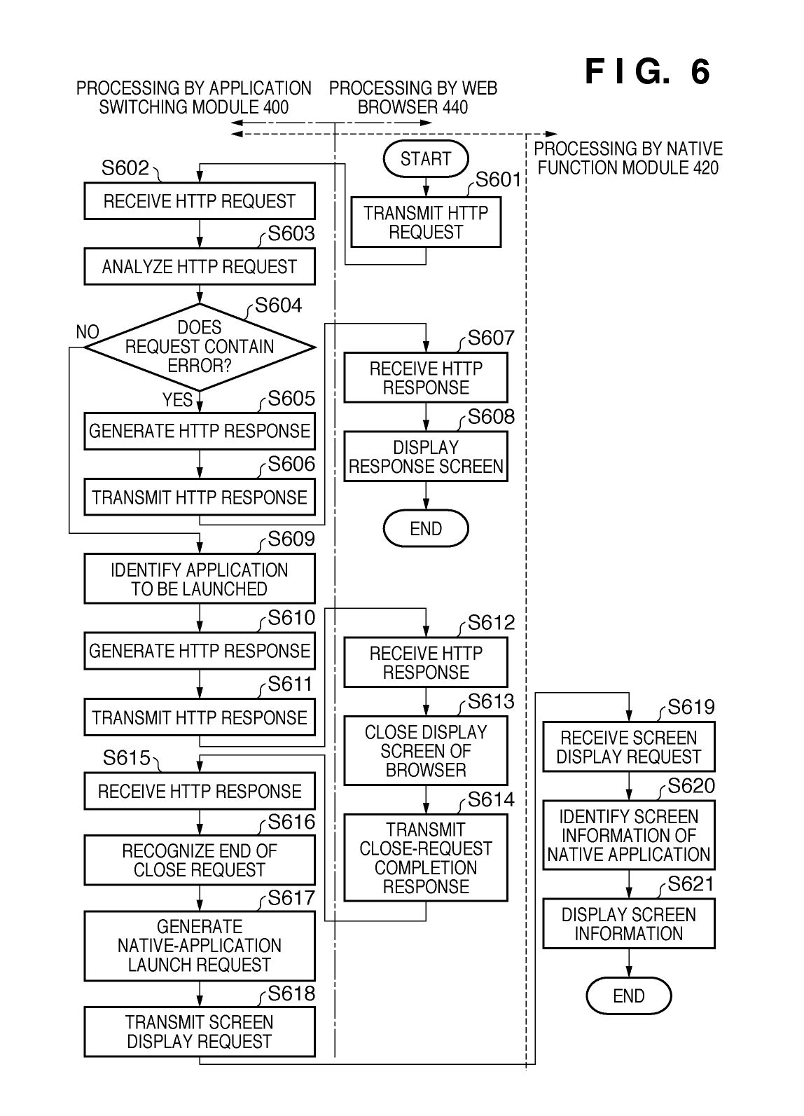

FIG. 6 is a flowchart for describing an example of processing executed by the MFP 101 according to the first embodiment. The processing indicated by the flowchart of FIG. 6 starts being executed in a state that prevails after the execution of the processing of the flowchart of FIG. 5, namely in a state in which the console unit 219 is displaying the operation screen (log-in screen) shown in FIG. 7B. The processing shown in the flowchart of FIG. 6 starts being executed also in a case where an operation screen other than this screen is being displayed on the console unit 219. The processing steps shown in the flowchart of FIG. 6 are implemented by having the CPU 211 of MFP 101 execute a control program. It should be noted that steps S601, S607, S608 and steps S612 to S614 are executed by the web browser 440. Steps S602 to S606, steps S609 to S611 and steps S615 to S618 indicate processing executed by the application switching module 400, and steps S619 to S621 indicate processing executed by the native function module 420.

First, in step S601, the web browser 440 transmits request information to the application switching module 400. The request information is transmitted via the communication section 443.

The request information includes information that the user has input on the log-in screen of FIG. 7B.

Specifically, the user enters a user ID and password on the log-in screen shown in FIG. 7B. If the user presses an OK button 702 after entering this information, then, in step S601, the web browser 440 transmits an HTTP request, which relates to the information that has been entered on the log-in screen, to the application switching module 400 as the request information.

In step S602, the request receiving section 409 receives the request information transmitted in step S601. Then, in step S603, the request data analyzing section 401 analyzes the received request information and recognizes the kind of request information that has been transmitted. Next, in step S604, the request data analyzing section 401 determines whether the content of the analyzed request information includes an error. If it is determined that the information includes an error, control proceeds to step S605 and the response data generating section 403 generates response information that indicates the content of the error. The response information is in a format such as that of an HTML file capable of being processed by the web browser 440. Next, in step S606, the request sending section 405 transmits the response information generated in step S605 to the web browser 440 via the communication section 408.

As a result, in step S607 the web browser 440 receives, via the communication section 443, the response information generated in step S606. Then, in step S608, the analyzing section 442 displays an operation screen, which has been obtained based upon the results of analyzing the received response information, on the console unit 219.

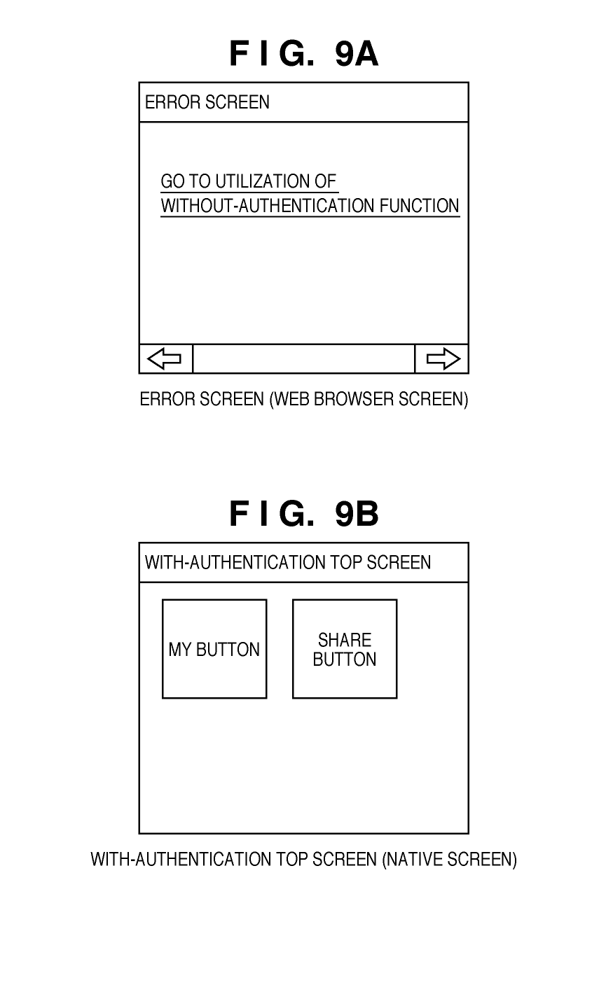

FIG. 9A illustrates an example of an operation screen displayed on the console unit 219 in step S608. FIG. 9A illustrates an example in which “ERROR SCREEN” is displayed by the web browser 440.

In the example of this screen, the user is provided with a function that makes it possible to specify a transition to “GO TO UTILIZATION OF WITHOUT-AUTHENTICATION FUNCTION”.

If it is determined in step S604 that the content of the request information analyzed in step S603 does not include an error, on the other hand, then control proceeds to step S609. This corresponds to a case where execution of the processing shown in the flowchart of FIG. 6 started in a state in which the log-in screen of FIG. 7B was being displayed. In this case, the request data generating section 404 generates request information directed toward the web application 430. This request information includes a user ID and password contained in the request information received in step S602. The request sending section 405 then transmits the request information to the web application 430. The web application 430 then executes authentication processing that is based upon the user ID and password included in the received request information and sends information indicative of authentication pass/fail back to the application switching module 400 as response information. As a result, the operation screen management section 410 acquires the operation screen management table in step S609. Then, based upon the operation screen management table and the response information from the web application 430, the operation screen management section 410 identifies the operation screen to be displayed on the console unit 219. For example, if the response information from the web application 430 indicates that authentication has succeeded, then the operation screen management section 410 identifies the fact that the native function is to display a with-authentication top screen. Further, if the response information from the web application 430 indicates an authentication error, then the operation screen management section 410 identifies the fact that the web browser is to display an error response screen. Next, in step S610, the response data generating section 403 is called and generates response information. This response information contains a description of information indicative of a request to close the web browser 440. In step S611, the response sending section 406 sends the web browser 440 the response information generated in step S610.

Thus, the web browser 440 receives this response information via the communication section 443 in step S612. Next, in step S613, the analyzing section 442 analyzes this response information and delivers the result of analysis to the screen display section 441. Specifically, since the content of the request is a request to close the display screen, processing to close the display screen of the web browser 440 is executed. Next, in step S614, response information to notify that processing with respect to the received request in step S613 has been completed is transmitted to the application switching module 400 via the communication section 443.

As a result, in step S615, the request receiving section 409 receives the response information transmitted in step S614. Then, in step S616, the request data analyzing section 401 analyzes this response information and recognizes that the screen based upon the web browser has been closed. In step S617, the request data generating section 404 is called and generates a screen display request in a format capable of being received by the native function module 420. The screen display request includes information concerning the application, identified in step S609, that is to be launched. In step S618, the request sending section 405 is called and transmits the screen display request generated in step S617 to the native function module 420. The screen display request includes information indicating what kind of operation screen is to be displayed by the native function module 420.

As a result, processing by the native function module 420 begins. First, in step S619, the screen request receiving section 423 receives the screen display request transmitted in step S618 and recognizes the kind of screen whose display is requested. Next, in step S620, based upon the request information received in step S619, the screen data management section 422 displays the operation screen that is to be displayed on the console unit 219.

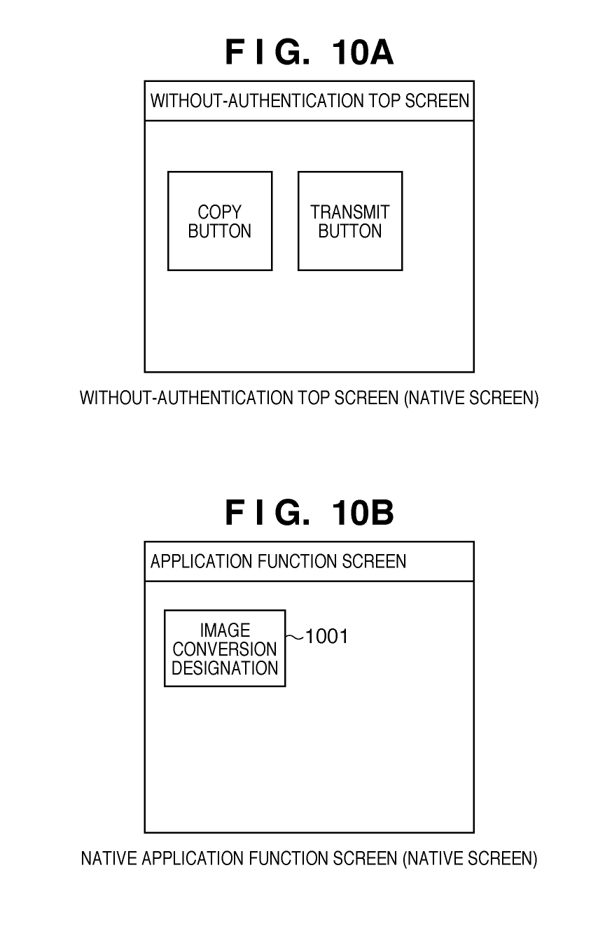

FIG. 9B illustrates an example in which “WITH-AUTHENTICATION TOP SCREEN” is displayed in accordance with the content of the authentication result, and FIG. 10A is a diagram illustrating an example in which “WITHOUT-AUTHENTICATION TOP SCREEN” is displayed in accordance with the authentication result.

The “WITH-AUTHENTICATION TOP SCREEN” of FIG. 9B is an operation screen displayed on the console unit 219 in a case where authentication performed by the web application 430 succeeded. On the other hand, “WITHOUT-AUTHENTICATION TOP SCREEN” of FIG. 10A is an operation screen displayed on the console unit 219 in a case where authentication performed by the web application 430 failed (resulted in an error). The “WITHOUT-AUTHENTICATION TOP SCREEN” of FIG. 10A provides the user with functions that can be utilized without user authentication.

Thus, in accordance with the first embodiment, the application switching module 400 switches between a screen display based upon the web browser 440 and a screen display based upon a native function in accordance with the contents of the operation screen management table shown in FIG. 8. Further, owing to the fact that the application switching module 400 issues a request to halt the screen display based upon the web browser 440 and to display the screen based upon a native application, an existing native function can utilize a function provided by the web server 102.

It should be noted that functions in addition to native functions can be added to the MFP 101. An application for implementing an additional function will be referred to as an “additional application”. As described earlier, user authentication is required to be carried out in a case where the user utilizes a native application of the MFP 101. In a case where an additional function is utilized as well, it is desired to arrange it so that the additional function is utilized upon first performing user authentication in a manner similar to that of a native function. In this case, a record correlated so as to display a log-in screen as an operation screen to be displayed in a case where a request relating to an additional function has been issued is described in the operation screen management table of FIG. 8 (see 810 in FIG. 8). This makes it possible to perform user authentication in the same way as when a native function is utilized even in a case where the user utilizes an additional function.

### Second Embodiment

A second embodiment of the present invention will now be described. Described in the second embodiment is an example in which an operation screen to be displayed by the web browser 440 of the MFP 101 is requested by pressing a specific button while the MFP 101, which is one example of an information processing apparatus, is providing the user with a native function. This makes it possible for a function for converting an image provided from the web application 430 to be utilized by the native function. The web application 430 determines whether an image file to be converted has been received from the MFP 101 and transmits an operation screen to the MFP 101 after the file is received. It should be noted that the configuration of the system and the configurations of the MFP 101 and web server 102 according to the second embodiment are similar to those of the first embodiment and need not be described again.

FIG. 10B is a diagram illustrating an example of a native application function screen presented to the user in connection with the start of the processing shown in FIG. 5.

If an image conversion designation button 1001 is pressed, an image conversion designation application presented by the application function screen starts. When the button 1001 is pressed, an image conversion designation request is transmitted to the web application 430 and the processing shown in FIG. 5 is executed. The processing steps shown in the flowchart of FIG. 5 are implemented by having the CPU 211 of MFP 101 execute the control program. It should be noted that steps S501 and S502 and steps S506 to S510 indicate processing executed by the application switching module 400. Steps S503 and S504 indicate processing steps executed by the web application 430, and steps S511 and S512 are processing steps executed by the web browser 440. Here only processing relating to the second embodiment will be described; processing similar to that of the first embodiment need not be described again.

An application to be launched is identified in step S508.

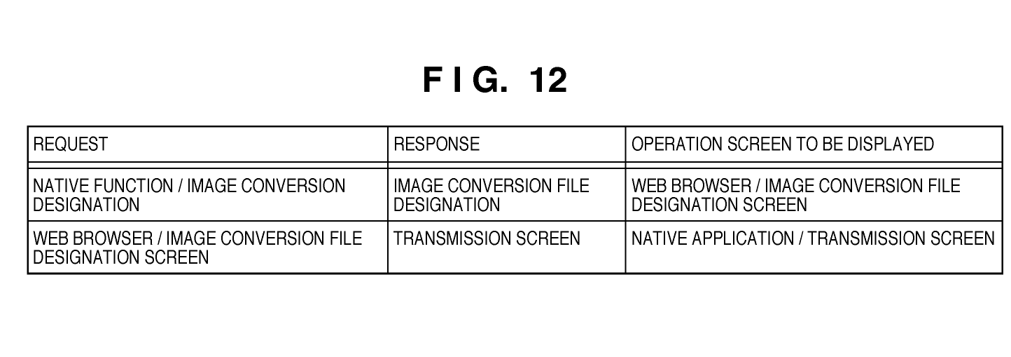

FIG. 12 is a diagram illustrating an example of an operation screen management table managed by the operation screen management section 410 according to the second embodiment.

In this example, an application that displays “IMAGE CONVERSION FILE DESIGNATION SCREEN” on the web browser 440 is launched when an “IMAGE CONVERSION DESIGNATION” request is issued from a native application function.

Accordingly, the response information analyzed in step S507 includes the “IMAGE CONVERSION FILE DESIGNATION SCREEN”. As a result, the application to be launched is identified on the image conversion file designation screen (web browser 440) and a response is transmitted to the web browser 440 through steps S509 and S510. In steps S511 and S512, therefore, the “IMAGE CONVERSION FILE DESIGNATION SCREEN” is displayed by the web browser 440 in accordance with this response.

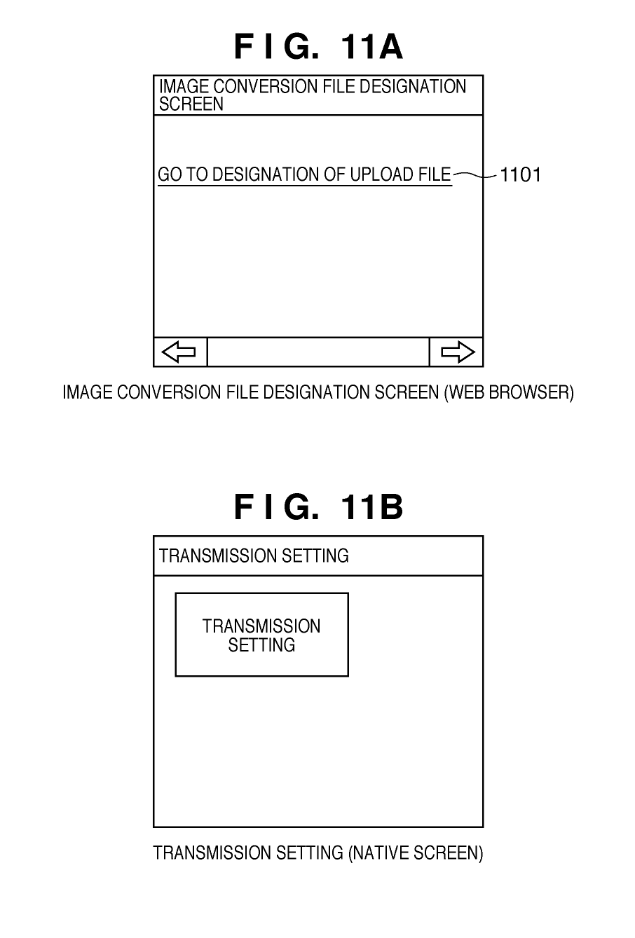

FIG. 11A is a diagram illustrating an example of the “IMAGE CONVERSION FILE DESIGNATION SCREEN”.

Here the image conversion file designation screen is presented to the user. The user presses “GO TO DESIGNATION OF UPLOAD FILE” 1101. As a result, information related to the “IMAGE CONVERSION FILE DESIGNATION SCREEN” is transmitted to the application switching module 400 as the HTTP request in step S601 in FIG. 6. The processing steps shown in the flowchart of FIG. 6 are implemented by having the CPU 211 of MFP 101 execute the control program. It should be noted that steps S601, S607, S608 and steps S612 to S614 are executed by the web browser 440. Steps S602, S603, steps S609 to S611 and steps S615 to S618 indicate processing executed by the application switching module 400, and steps S619 to S621 indicate processing executed by the native function module 420.

If it is determined in step S603 that the HTTP request is the image conversion file designation display, control proceeds from step S604 to step S609 and the application to be launched is identified. As a result of comparing the analyzed request of step S603 and the table of FIG. 12, the analyzed request of step S603 is identified as the image conversion file designation display. Accordingly, information regarding the application to be launched is identified.

Next, in step S610, the response data generating section 403 is called and generates an HTTP response such as an HTML file in a file format capable of being received by the web application 430. Described in this HTTP response is a response for closing the web browser 440. The response sending section 406 is then called in step S611 and transmits the HTTP response generated in step S610 to the web browser 440. At this time the request sending section 405 transmits the HTTP request via the communication section 408.

Next, the web browser 440 receives this HTTP response via the communication section 443 in step S612. Next, the analyzing section 442 is called in step S613, delivers the result of analysis of the HTTP response information received in step S612 to the screen display section 441 and displays the result on the screen as the received response. More specifically, since the content of the response is a request to close the display screen, processing to close the display screen of the web browser 440 is executed. Next, in step S614, HTTP response information for giving notification that processing with respect to the received response in step S613 has been completed is transmitted to the application switching module 400 via the communication section 443.

As a result, the application switching module 400 calls the response receiving section 407 via the communication section 408 in step S615 and receives the HTTP response transmitted in step S614. Next, in step S616, the application switching module 400 calls the response data analyzing section 402 and analyzes the information received in the HTTP response, thereby recognizing that the close request has ended. Next, in step S617, the request data generating section 404 is called and generates a screen display request in a format capable of being received by the native function module 420. The screen display request includes information concerning the application to be launched identified in step S609. Then, in step S618, the request sending section 405 is called and sends to the native function module 420 the screen display request generated in step S617. In a case where the application that is the source of the request transmission is the “IMAGE CONVERSION FILE DESIGNATION SCREEN (WEB BROWSER)”, the application to be launched is a “TRANSMISSION SCREEN (NATIVE APPLICATION SCREEN)”, as illustrated in FIG. 12.

As a result, processing by the native function module 420 starts following step S618. First, in step S619, the screen request receiving section 423 is called, receives the screen display request transmitted in step S618 and recognizes what kind of screen display has been requested. Next, in step S620, the screen data management section 422 is called and acquires a list of managed screen information. Then, by comparing the acquired list information and the request information received in step S619, the screen data management section 422 identifies the screen information that is to be displayed on the native function screen. Next, in step S621, the screen display section 421 is called and delivers to the screen display section 421 the screen information to be displayed identified in step S620, thereby displaying the screen information on the operation screen.

FIG. 11B illustrates an example of a “TRANSMISSION SCREEN” provided by the native function application following the “IMAGE CONVERSION FILE DESIGNATION SCREEN” processing. Owing to the fact that the analyzed request information is switched over in step S609, the native application function screen is provided to the user and the native function is capable of utilizing the function provided by the web server 102.

In accordance with this embodiment, as described above, a screen display conforming to a request from a web browser can be readily presented in an application that executes a function (a native function) inherently possessed by an information processing apparatus.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-183387, filed Aug. 18, 2010, which is hereby incorporated by reference herein in its entirety.

What is claimed is:

1. An information processing apparatus having a web server, comprising:
an application configured to execute a function possessed by the information processing apparatus;
a storage unit configured to store information identifying the type and issuing source of a request, which has been issued from the application or the web browser, and an operation screen displayed by the application or the web browser in response to the request;
an analyzing unit configured to analyze a request that has been input using an operation screen being displayed by the web browser or the application;
an identification unit configured to refer to the stored information based upon result of analysis by the analyzing unit and identify an operation screen that is to be displayed by the application or the web browser; and
a requesting unit configured to request the application or the web browser to display the operation screen identified by the identification unit.

2. The apparatus according to claim 1, further comprising an error response unit configured to display an operation screen by the web browser if it is determined, based upon the result of analysis by the analyzing unit, that the request contains an error.

3. The apparatus according to claim 1, further comprising a transition unit configured to transition to display a log-in screen by the web browser when launching of the application is specified using an initial screen of the application.

4. The apparatus according to claim 3, wherein the requesting unit requests the application to display an operation screen for utilizing the application if a request that has been input using the log-in screen presented by the web browser does not contain an error.

5. A method of controlling an information processing apparatus having a web browser, comprising:
an execution step of executing a function possessed by the information processing apparatus by an application stored in the information processing apparatus;
an analyzing step of analyzing a request that has been input using an operation screen being displayed by the web browser or the application;
an identification step of referring to information, which identifies the type and issuing source of a request that has been issued from the application or web browser and an operation screen displayed by the application or web browser in response to the request, based upon result of analysis in the analyzing step, and identifying an operation screen that is to be displayed by the application or web browser in response to the request; and
a requesting step of requesting the application or web browser to display the operation screen identified in the identification step.
